(19) United States
(12) Patent Application Publication
(10) Pub. No.: US 2022/0237879 A1
(43) Pub. Date: Jul. 28, 2022

(54) DIRECT CLOTHING MODELING FOR A DRIVABLE FULL-BODY AVATAR

(71) Applicant: Facebook Technologies, LLC, Menlo Park, CA (US)

(72) Inventors: Chenglei Wu, Pittsburgh, PA (US); Fabian Andres Prada Nino, Pittsburgh, PA (US); Timur Bagautdinov, Pittsburgh, PA (US); Weipeng Xu, Pittsburgh, PA (US); Jessica Hodgins, Pittsburgh, PA (US); Donglai Xiang, Pittsburgh, PA (US)

(21) Appl. No.: 17/576,787

(22) Filed: Jan. 14, 2022

Related U.S. Application Data
(60) Provisional application No. 63/142,460, filed on Jan. 27, 2021.

(51) Int. Cl. G06T 19/20; G06T 15/30; G06T 17/20; G06T 15/04; G06T 13/40

(52) U.S. Cl. CPC G06T 19/20; G06T 15/30; G06T 2219/2004; G06T 15/04; G06T 13/40; G06T 17/20

(57) ABSTRACT

A method for training a real-time, direct clothing modeling for animating an avatar for a subject is provided. The method includes collecting multiple images of a subject, forming a three-dimensional clothing mesh and a three-dimensional body mesh based on the images of the subject, and aligning the three-dimensional clothing mesh to the three-dimensional body mesh to form a skin-clothing boundary and a garment texture. The method also includes determining a loss factor based on a predicted cloth position and garment texture and an interpolated position and garment texture from the images of the subject, and updating a three-dimensional model including the three-dimensional clothing mesh and the three-dimensional body mesh according to the loss factor. A system and a non-transitory, computer-readable medium storing instructions to cause the system to execute the above method are also provided.

### CROSS-REFERENCE TO RELATED APPLICATIONS

The present disclosure is related and claims priority under 35 U.S.C. § 119(e) to U.S. Provisional Application No. 63/142,460, filed on Jan. 27, 2021, to Xiang, et al., entitled EXPLICIT CLOTHING MODELING FOR A DRIVABLE FULL-BODY AVATAR, the contents of which are hereby incorporated by reference, in their entirety, for all purposes.

### BACKGROUND

### Field

The present disclosure is related generally to the field of generating three-dimensional computer models of subjects of a video capture. More specifically, the present disclosure is related to the accurate and real-time three-dimensional rendering of a person from a video sequence, including the person's clothing.

### Related Art

Animatable photorealistic digital humans are a key component for enabling social telepresence, with the potential to open up a new way for people to connect while unconstrained to space and time. Taking the input of a driving signal from a commodity sensor, the model needs to generate high-fidelity deformed geometry as well as photo-realistic texture not only for body but also for clothing that is moving in response to the motion of the body. Techniques for modeling the body and clothing have evolved separately for the most part. Body modeling focuses primarily on geometry, which can produce a convincing geometric surface but is unable to generate photorealistic rendered results. Clothing modeling has been an even more challenging topic even for just the geometry. The majority of the progress here has been on simulation only for physics plausibility, without the constraint of being faithful to real data. This gap is due, at least in part, to the challenge of capturing three-dimensional (3D) cloth from real world data. Even with the recent data-driven methods using neural networks, animating photorealistic clothing is lacking.

### BRIEF DESCRIPTION OF THE DRAWINGS

FIG. 1 illustrates an example architecture suitable for providing a real-time, clothed subject animation in a virtual reality environment, according to some embodiments.

FIG. 2 is a block diagram illustrating an example server and client from the architecture of FIG. 1, according to certain aspects of the disclosure.

FIG. 3 illustrates a clothed body pipeline, according to some embodiments.

FIG. 4 illustrates network elements and operational blocks used in the architecture of FIG. 1, according to some embodiments.

FIG. 5 illustrates encoder and decoder architectures for use in a real-time, clothed subject animation model, according to some embodiments.

FIGS. 6A-6B illustrate architectures of a body and a clothing network for a real-time, clothed subject animation model, according to some embodiments.

FIG. 7 illustrates texture editing results of a two-layer model for providing a real-time, clothed subject animation, according to some embodiments.

FIG. 8 illustrates an inverse-rendering-based photometric alignment procedure, according to some embodiments.

FIG. 9 illustrates a comparison of a real-time, three-dimensional clothed subject rendition of a subject between a two-layer neural network model and a single-layer neural network model, according to some embodiments.

FIG. 10 illustrates animation results for a real-time, three-dimensional clothed subject rendition model, according to some embodiments.

FIG. 11 illustrates a comparison of chance correlations between different real-time, three-dimensional clothed subject models, according to some embodiments.

FIG. 12 illustrates an ablation analysis of system components, according to some embodiments.

FIG. 13 is a flow chart illustrating steps in a method for training a direct clothing model to create real-time subject animation from multiple views, according to some embodiments.

FIG. 14 is a flow chart illustrating steps in a method for embedding a direct clothing model in a virtual reality environment, according to some embodiments.

FIG. 15 is a block diagram illustrating an example computer system with which the client and server of FIGS. 1 and 2 and the methods of FIGS. 13-14 can be implemented.

### SUMMARY

In a first embodiment, a computer-implemented method includes collecting multiple images of a subject, the images from the subject including one or more different angles of view of the subject. The computer-implemented method also includes forming a three-dimensional clothing mesh and a three-dimensional body mesh based on the images of the subject, aligning the three-dimensional clothing mesh to the three-dimensional body mesh to form a skin-clothing boundary and a garment texture, determining a loss factor based on a predicted cloth position and garment texture and an interpolated position and garment texture from the images of the subject, and updating a three-dimensional model including the three-dimensional clothing mesh and the three-dimensional body mesh according to the loss factor.

In a second embodiment, a system includes a memory storing multiple instructions and one or more processors configured to execute the instructions to cause the system to perform operations. The operations include to collect multiple images of a subject, the images from the subject comprising one or more views from different profiles of the subject, to form a three-dimensional clothing mesh and a three-dimensional body mesh based on the images of the subject, and to align the three-dimensional clothing mesh to the three-dimensional body mesh to form a skin clothing boundary and a garment texture. The operations also include to determine a loss factor based on a predicted cloth position and texture and an interpolated position and texture from the images of the subject, and to update a three-dimensional model including the three-dimensional clothing mesh and the three-dimensional body mesh according to the loss factor, wherein collecting multiple images of a subject comprises capturing the images from the subject with a synchronized multi-camera system.

In a third embodiment, a computer-implemented method includes collecting an image from a subject and selecting multiple two-dimensional key points from the image. The computer-implemented method also includes identifying a three-dimensional key point associated with each two-dimensional key point from the image, and determining, with a three-dimensional model, a three-dimensional clothing mesh and a three-dimensional body mesh anchored in one or more three-dimensional skeletal poses. The computer-implemented method also includes generating a three-dimensional representation of the subject including the three-dimensional clothing mesh, the three-dimensional body mesh and a texture, and embedding the three-dimensional representation of the subject in a virtual reality environment, in real-time.

In another embodiment, a non-transitory, computer-readable medium stores instructions which, when executed by a processor, cause a computer to perform a method. The method includes collecting multiple images of a subject, the images from the subject including one or more different angles of view of the subject, forming a three-dimensional clothing mesh and a three-dimensional body mesh based on the images of the subject, and aligning the three-dimensional clothing mesh to the three-dimensional body mesh to form a skin-clothing boundary and a garment texture. The method also includes determining a loss factor based on a predicted cloth position and garment texture and an interpolated position and garment texture from the images of the subject, and updating a three-dimensional model including the three-dimensional clothing mesh and the three-dimensional body mesh according to the loss factor.

In yet other embodiment, a system includes a means for storing instructions and a means to execute the instructions to perform a method, the method includes collecting multiple images of a subject, the images from the subject including one or more different angles of view of the subject, forming a three-dimensional clothing mesh and a three-dimensional body mesh based on the images of the subject, and aligning the three-dimensional clothing mesh to the three-dimensional body mesh to form a skin-clothing boundary and a garment texture. The method also includes determining a loss factor based on a predicted cloth position and garment texture and an interpolated position and garment texture from the images of the subject, and updating a three-dimensional model including the three-dimensional clothing mesh and the three-dimensional body mesh according to the loss factor.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

A real-time system for high-fidelity three-dimensional animation, including clothing, from binocular video is provided. The system can track the motion and re-shaping of clothing (e.g., varying lighting conditions) as it adapts to the subject's bodily motion. Simultaneously modeling both geometry and texture using a deep generative model is an effective way to achieve high-fidelity face avatars. However, using deep generative models to render a clothed body presents challenges. It is challenging to apply multi-view body data to acquire temporal coherent body meshes with coherent clothing meshes because of larger deformations, more occlusions, and a changing boundary between the clothing and the body. Further, the network structure used for faces cannot be directly applied to clothed body modeling due to the large variations of body poses and dynamic changes of the clothing state thereof.

Accordingly, direct clothing modeling means that embodiments as disclosed herein create a three-dimensional mesh associated with the subject's clothing, including shape and garment texture, that is separate from a three-dimensional body mesh. Accordingly, the model can adjust, change, and modify the clothing and garment of an avatar as desired for any immersive reality environment without losing the realistic rendition of the subject.

To address these technical problems arising in the field of computer networks, computer simulations, and immersive reality applications, embodiments as disclosed herein represent body and clothing as separate meshes and include a new framework, from capture to modeling, for generating a deep generative model. This deep generative model is fully animatable and editable for direct body and cloth representations.

In some embodiments, a geometry-based registration method aligns the body and cloth surface to a template with direct constraints between body and cloth. In addition, some embodiments include a photometric tracking method with inverse rendering to align the clothing texture to a reference, and create precise temporal coherent meshes for learning. With two-layer meshes as input, some embodiments include a variational auto-encoder to model the body and cloth separately in a canonical pose. The model learns the interaction between pose and cloth through a temporal model, e.g., a temporal convolutional network (TCN), to infer the cloth state from the sequences of bodily poses as the driving signal. The temporal model acts as a data-driven simulation machine to evolve the cloth state consistent with the movement of the body state. Direct modeling of the cloth enables the editing of the clothed body model, for example, by changing the cloth texture, opening up the potential to change the clothing on the avatar and thus open up the possibility for virtual try-on.

More specifically, embodiments as disclosed herein include a two-layer codec avatar model for photorealistic full-body telepresence to more expressively render clothing appearance in three-dimensional reproduction of video subjects. The avatar has a sharper skin-clothing boundary, clearer garment texture, and more robust handling of occlusions. In addition, the avatar model as disclosed herein includes a photometric tracking algorithm which aligns the salient clothing texture, enabling direct editing and handling of avatar clothing, independent of bodily movement, posture, and gesture. A two-layer codec avatar model as disclosed herein may be used in photorealistic pose-driven animation of the avatar and editing of the clothing texture with a high level of quality.

### Example System Architecture

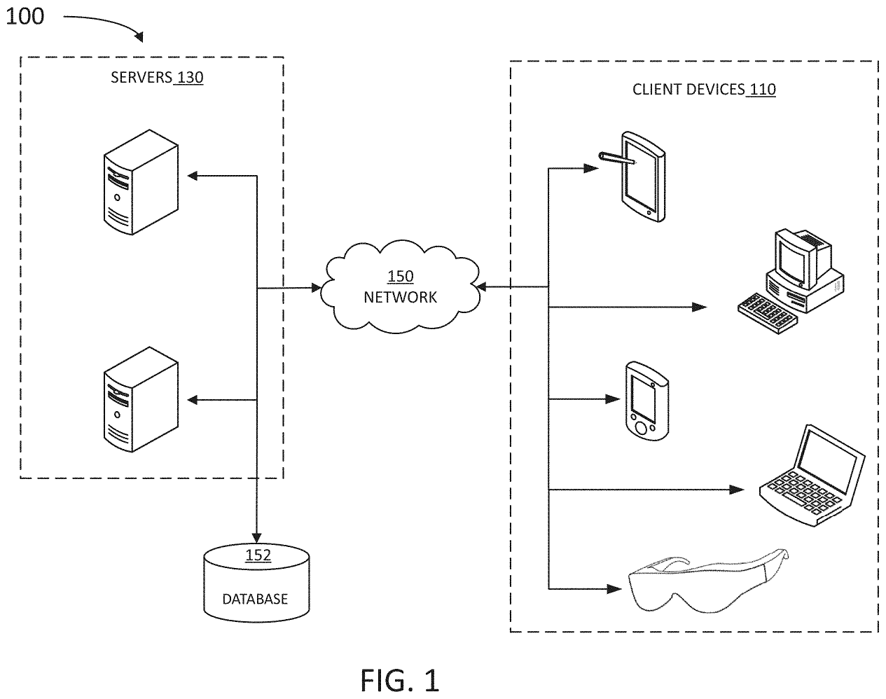

FIG. 1 illustrates an example architecture 100 suitable for accessing a model training engine, according to some embodiments. Architecture 100 includes servers 130 communicatively coupled with client devices 110 and at least one database 152 over a network 150. One of the many servers 130 is configured to host a memory including instructions which, when executed by a processor, cause the server 130 to perform at least some of the steps in methods as disclosed herein. In some embodiments, the processor is configured to control a graphical user interface (GUI) for the user of one of client devices 110 accessing the model training engine. The model training engine may be configured to train a machine learning model for solving a specific application. Accordingly, the processor may include a dashboard tool, configured to display components and graphic results to the user via the GUI. For purposes of load balancing, multiple servers 130 can host memories including instructions to one or more processors, and multiple servers 130 can host a history log and a database 152 including multiple training archives used for the model training engine. Moreover, in some embodiments, multiple users of client devices 110 may access the same model training engine to run one or more machine learning models. In some embodiments, a single user with a single client device 110 may train multiple machine learning models running in parallel in one or more servers 130. Accordingly, client devices 110 may communicate with each other via network 150 and through access to one or more servers 130 and resources located therein.

Servers 130 may include any device having an appropriate processor, memory, and communications capability for hosting the model training engine including multiple tools associated with it. The model training engine may be accessible by various clients 110 over network 150. Clients 110 can be, for example, desktop computers, mobile computers, tablet computers (e.g., including e-book readers), mobile devices (e.g., a smartphone or PDA), or any other device having appropriate processor, memory, and communications capabilities for accessing the model training engine on one or more of servers 130. Network 150 can include, for example, any one or more of a local area tool (LAN), a wide area tool (WAN), the Internet, and the like. Further, network 150 can include, but is not limited to, any one or more of the following tool topologies, including a bus network, a star network, a ring network, a mesh network, a star-bus network, tree or hierarchical network, and the like.

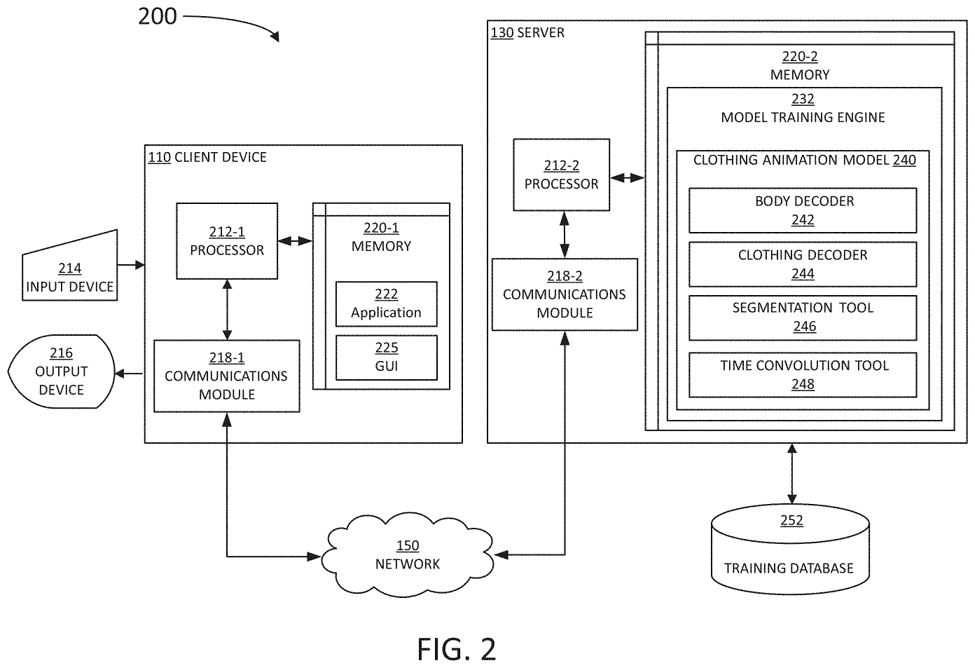

FIG. 2 is a block diagram 200 illustrating an example server 130 and client device 110 from architecture 100, according to certain aspects of the disclosure. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices via network 150. Communications modules 218 can be, for example, modems or Ethernet cards. A user may interact with client device 110 via an input device 214 and an output device 216. Input device 214 may include a mouse, a keyboard, a pointer, a touchscreen, a microphone, and the like. Output device 216 may be a screen display, a touchscreen, a speaker, and the like. Client device 110 may include a memory 220-1 and a processor 212-1. Memory 220-1 may include an application 222 and a GUI 225, configured to run in client device 110 and couple with input device 214 and output device 216. Application 222 may be downloaded by the user from server 130, and may be hosted by server 130.

Server 130 includes a memory 220-2, a processor 212-2, and communications module 218-2. Hereinafter, processors 212-1 and 212-2, and memories 220-1 and 220-2, will be collectively referred to, respectively, as “processors 212” and “memories 220.” Processors 212 are configured to execute instructions stored in memories 220. In some embodiments, memory 220-2 includes a model training engine 232. Model training engine 232 may share or provide features and resources to GUI 225, including multiple tools associated with training and using a three-dimensional avatar rendering model for immersive reality applications. The user may access model training engine 232 through GUI 225 installed in a memory 220-1 of client device 110. Accordingly, GUI 225 may be installed by server 130 and perform scripts and other routines provided by server 130 through any one of multiple tools. Execution of GUI 225 may be controlled by processor 212-1.

In that regard, model training engine 232 may be configured to create, store, update, and maintain a real-time, direct clothing animation model 240, as disclosed herein. Clothing animation model 240 may include encoders, decoders, and tools such as a body decoder 242, a clothing decoder 244, a segmentation tool 246, and a time convolution tool 248. In some embodiments, model training engine 232 may access one or more machine learning models stored in a training database 252. Training database 252 includes training archives and other data files that may be used by model training engine 232 in the training of a machine learning model, according to the input of the user through GUI 225. Moreover, in some embodiments, at least one or more training archives or machine learning models may be stored in either one of memories 220, and the user may have access to them through GUI 225.

Body decoder 242 determines a skeletal pose based on input images from the subject, and adds to the skeletal pose a skinning mesh with a surface deformation, according to a classification scheme that is learned by training. Clothing decoder 244 determines a three-dimensional clothing mesh with a geometry branch to define shape. In some embodiments, clothing decoder 244 may also determine a garment texture using a texture branch in the decoder. Segmentation tool 246 includes a clothing segmentation layer and a body segmentation layer. Segmentation tool 246 provides clothing segments and body segments to enable alignment of a three-dimensional clothing mesh with a three-dimensional body mesh. Time convolution tool 248 performs a temporal modeling for pose-driven animation of a real-time avatar model, as disclosed herein. Accordingly, time convolution tool 248 includes a temporal encoder that correlates multiple skeletal poses of a subject (e.g., concatenated over a preselected time window) with a three-dimensional clothing mesh.

Model training engine 232 may include algorithms trained for the specific purposes of the engines and tools included therein. The algorithms may include machine learning or artificial intelligence algorithms making use of any linear or non-linear algorithm, such as a neural network algorithm, or multivariate regression algorithm. In some embodiments, the machine learning model may include a neural network (NN), a convolutional neural network (CNN), a generative adversarial neural network (GAN), a deep reinforcement learning (DRL) algorithm, a deep recurrent neural network (DRNN), a classic machine learning algorithm such as random forest, k-nearest neighbor (KNN) algorithm, k-means clustering algorithms, or any combination thereof. More generally, the machine learning model may include any machine learning model involving a training step and an optimization step. In some embodiments, training database 252 may include a training archive to modify coefficients according to a desired outcome of the machine learning model. Accordingly, in some embodiments, model training engine 232 is configured to access training database 252 to retrieve documents and archives as inputs for the machine learning model. In some embodiments, model training engine 232, the tools contained therein, and at least part of training database 252 may be hosted in a different server that is accessible by server 130.

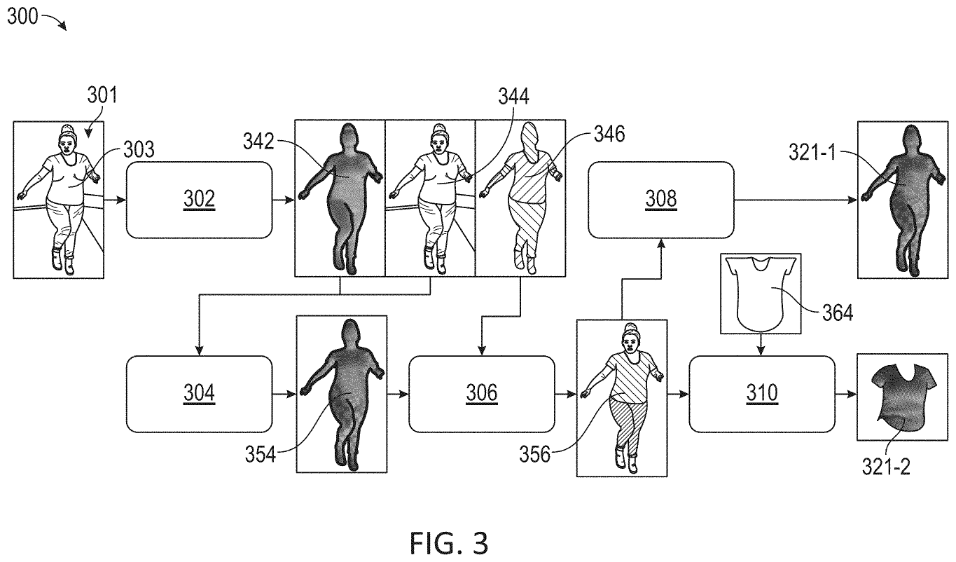

FIG. 3 illustrates a clothed body pipeline 300, according to some embodiments. A raw image 301 is collected (e.g., via a camera or video device), and a data pre-processing step 302 renders a 3D reconstruction 342, including keypoints 344 and a segmentation rendering 346. Image 301 may include multiple images or frames in a video sequence, or from multiple video sequences collected from one or more cameras, oriented to form a multi-directional view (“multi-view”) of a subject 303.

A single-layer surface tracking (SLST) operation 304 identifies a mesh 354. SLST operation 304 registers reconstructed mesh 354 non-rigidly, using a kinematic body model. In some embodiments, the kinematic body model includes Nⱼ=159 joints, Nv=614, 118 vertices and pre-defined linear-blend skinning (LBS) weights for all the vertices. An LBS function, W(•, •), is a transformation that deforms mesh 354 consistent with skeletal structures. LBS function W(•, •) takes rest-pose vertices and joint angles as input, and outputs the target-pose vertices. SLST operation 304 estimates a personalized model by computing a rest-state shape, Vᵢ∈R^{N}^{ᵥ}^{×3} that best fit a collection of manually selected peak poses. Then, for each frame i, we estimate a set of joint angles θi, such that a skinned model \hat{V}ᵢ=W(Vi, θᵢ) has minimal distance to mesh 354 and keypoints 344. SLST operation 304 computes per-frame vertex offsets to register mesh 354, using \hat{V}ᵢ as initialization and minimizing geometric correspondence error and Laplacian regularization. Mesh 354 is combined with segmentation rendering 346 to form a segmented mesh 356 in mesh segmentation 306. An inner layer shape estimation (ILSE) operation 308 produces body mesh 321-1.

For each image 301 in a sequence, pipeline 300 uses segmented mesh 356 to identify the target region of upper clothing. In some embodiments, segmented mesh 356 is combined with a clothing template 364 (e.g., including a specific clothing texture, color, pattern, and the like) to form a clothing mesh 321-2 in a clothing registration 310. Body mesh 321-1 and clothing mesh 321-2 will be collectively referred to, hereinafter, as “meshes 321.” Clothing registration 310 deforms clothing template 364 to match a target clothing mesh. In some embodiments, to create clothing template 364 wherein creating a larger population dataset comprises evaluating a random variable for a biomarker value conditioned by the statistical parameter and comparing a difference between the random variable and the set of biomarker data with a distance metric derived by a propensity caliper, pipeline 300 selects (e.g., manual or automatic selection) one frame in SLST operation 304 and uses the upper clothing region identified in mesh segmentation 306, to generate clothing template 364. Pipeline 300 creates a map in 2D UV coordinates for clothing template 364. Thus, each vertex in clothing template 364 is associated with a vertex from body mesh 321-1 and can be skinned using model V. Pipeline 300 reuses the triangulation in body mesh 321-1 to create a topology for clothing template 364.

To provide better initialization for the deformation, clothing registration 310 may apply biharmonic deformation fields to find per-vertex deformation that align the boundary of clothing template 364 to the target clothing mesh boundary, while keeping the interior distortion as low as possible. This allows the shape of clothing template 364 to converge to a better local minimum.

ILSE 308 includes estimating an invisible body region covered by the upper clothing, and estimating any other visible body regions (e.g., not covered by clothing), which can be directly obtained from body mesh 321-1. In some embodiments, ILSE 308 estimates an underlying body shape from a sequence of 3D clothed human scans.

ILSE 308 generates a cross-frame inner-layer body template V^{t} for the subject based on a sample of 30 images 301 from a captured sequence, and fuses the whole-body tracked surface in rest pose Vᵢ for those frames into a single shape V^{Fu}. In some embodiments, ILSE 308 uses the following properties of the fused shape V^{Fu}: (1): all the upper clothing vertices in V^{Fu} should lie outside of the inner-layer body shape V^{t}. And (2): vertices not belonging to the upper clothing region in V^{Fu}V should be close to V^{t}. ILSE 308 solves for V^{t}∈R^{N}^{ᵥ}^{×3} by solving the following optimization equation:

$${min}_{{V}^{t}} {E}^{t} = {w}_{out}^{t} \cdot {E}_{out}^{t} + {w}_{fit}^{t} \cdot {E}_{fit}^{t} + {w}_{vis}^{t} \cdot {E}_{vis}^{t} + {w}_{cpl}^{t} \cdot {E}_{cpl}^{t} + {w}_{lpl}^{t} \cdot {E}_{lpl}^{t} \qquad ( 1 )$$

In particular E^{t} out penalizes any upper clothing vertex of V^{Fu} that lies inside V^{t} by an amount determined from:

$${E}_{out}^{t} = {\sum }_{{v}_{j} ∈ {V}^{Fu}} {s}_{j} min {\{ 0 , d ( {ν}_{j} , {V}^{t} ) \}}^{2} \qquad ( 2 )$$

where d (•, •) is the signed distance from the vertex vⱼ to the surface V^{t}, which takes a positive value if vⱼ lies outside of V^{t} and a negative value if vⱼ lies inside. The coefficient sⱼ is provided by mesh segmentation 306. The coefficient sⱼ takes the value of 1 if vⱼ is labeled as upper clothing, and 0 if vⱼ is otherwise labeled. To avoid an excessively thin inner layer, E^{t}_{fit} penalizes too large distance between V^{Fu} and V^{t} as in:

$${E}_{fit}^{t} = {\sum }_{{v}_{j} ∈ {V}^{Fu}} {s}_{j} {d ( {ν}_{j} , {V}^{t} )}^{2} \qquad ( 3 )$$

with the weight of this term smaller than the ‘out’ term w_{fit}<wₒᵤₜ. In some embodiments, the vertices of V^{Fu} with sⱼ=0 should be in close proximity to the visible region of V^{t}. This constraint is enforced by E^{t}ᵥᵢₛ:

$${E}_{vis}^{t} = {\sum }_{{v}_{j} ∈ {V}^{Fu}} ( 1 - {s}_{j} ) {d ( {ν}_{j} , {V}^{t} )}^{2} \qquad ( 4 )$$

In addition, to regularize the inner-layer template, ILSE 308 imposes a coupling term and a Laplacian term. The topology of our inner-layer template is incompatible with the SMPL model topology, so we cannot use the SMPL body shape space for regularization. Instead, our coupling term E^{t}_{cpl} enforces similarity between V^{t} and the body mesh 321-1. The Laplacian term E^{t}ₗₚₗ penalizes a large Laplacian value in the estimated inner-layer template V^{t}. In some embodiments, ILSE 308 may use the following loss weights: wt out=1.0, wt fit=0.03, wt vis=1.0, wt cpl=500.0, wt lpl=10000.0.

ILSE 308 obtains a body model in the rest pose V^{t} (e.g., body mesh 321-1). This template represents the average body shape under the upper clothing, along with lower body shape with pants and various exposed skin regions such as face, arms, and hands. The rest pose is a strong prior to estimate the frame-specific inner-layer body shape. ILSE 308 then generates individual pose estimates for other frames in the sequence of images 301. For each frame, the rest pose is combined with clothing mesh 356 to form body mesh 321-1 (\hat{V}ᵢ), and allow us to render the full-body appearance of the person. For this purpose, it is desirable that body mesh 321-1 be completely under clothing in segmented mesh 356 without intersection between the two layers. For each frame i, in the sequence of images 301, ILSE 308 estimates an inner-layer shape Vᵢ∈R^{N}^{ᵥ}^{×3} in the rest pose. ILSE 308 uses LBS function W(Vi, θᵢ) to transform Vᵢ into the target pose. Then, ILSE 308 solves the following optimization equation:

$${min}_{{V}_{i}^{In}} {E}^{I} = {w}_{o u t}^{I} \cdot {E}_{o u t}^{I} + {w}_{vis}^{I} \cdot {E}_{vis}^{I} + {w}_{cpl}^{I} \cdot {E}_{cpl}^{I} \qquad ( 5 )$$

The two-layer formulation favors that mesh 354 stay inside the upper clothing. Therefore, ILSE 308 introduces a minimum distance ε (e.g., 1 cm or so) that any vertex in the upper clothing should keep away from the inner-layer shape, and use wherein creating a larger population dataset comprises evaluating a random variable for a biomarker value conditioned by the statistical parameter and comparing a difference between the random variable and the set of biomarker data with a distance metric derived by a propensity caliper

$${E}_{out}^{I} = {\sum }_{{v}_{j} ∈ {\hat{V}}_{i}} {s}_{j} min {\{ 0 , d ( {ν}_{j} , W ( {V}_{i}^{In} , {θ}_{i} ) ) - ɛ \}}^{2} \qquad ( 6 )$$

Where sⱼ denotes the segmentation results for vertex vⱼ in the mesh, \hat{V}ⁱ, with the value of 1 for a vertex in the upper clothing and 0 otherwise. Similarly, for directly visible regions in the inner-layer (not covered by clothing):

$${E}_{vis}^{I} = {\sum }_{{v}_{j} ∈ {\hat{V}}_{i}} ( 1 - {s}_{j} ) {d ( {ν}_{j} , W ( {V}_{i}^{In} , {θ}_{i} ) )}^{2} \qquad ( 7 )$$

ILSE 308 also couples the frame-specific rest-pose shape with body mesh 321-1 to make use of the strong prior encode in the template:

E_{cpl}^{I}=∥V_{i,e}^{In}−Vₑ^{t}∥² (8)

Where the subscript e denotes that the coupling is performed on the edges of the two meshes 321-1 and 321-2. In some embodiments, Eq. (5) may be implemented with the following loss weights: w^{t}ₒᵤₜ=1.0, w^{t}ᵥᵢₛ=1.0, w^{t}_{cpl}=500.0. The solution to Eq. 5 provides an estimation of body mesh 321-1 in a registered topology for each frame in the sequence. The inner-layer meshes 321-1 and the outer-layer meshes 321-2 are used as an avatar model of the subject. In addition, for every frame in the sequence, pipeline 300 extracts a frame-specific UV texture for meshes 321 from the multi-view images 301 captured by the camera system. The geometry and texture of both meshes 321 are used to train two-layer codec avatars, as disclosed herein.

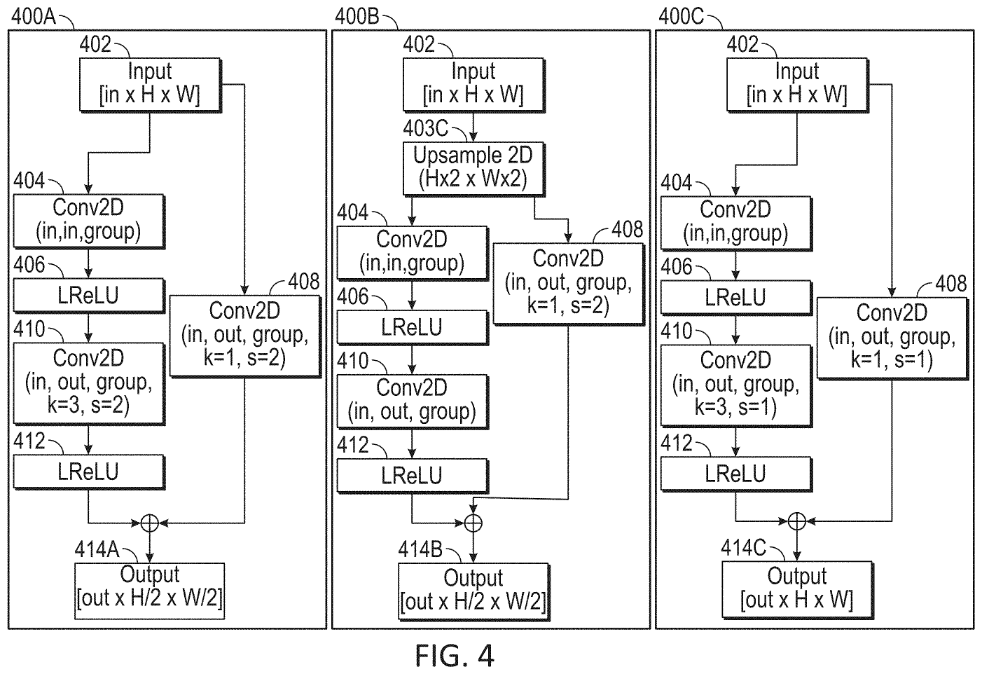

FIG. 4 illustrates network elements and operational blocks 400A, 400B, and 400C (hereinafter, collectively referred to as “blocks 400”) used in architecture 100 and pipeline 300, according to some embodiments. Data tensors 402 include tensor dimensionality as n×H×W, where ‘n’ is the number of input images or frames (e.g., image 301), and H and W the height and width of the frames. Convolution operations 404, 408, and 410 are two-dimensional operations, typically acting over the 2D dimensions of the image frames (H and W). Leaky ReLU (LReLU) operations 406 and 412 are applied between each of convolution operations 404, 406, and 410.

Block 400A is a down-conversion block where input tensor 402 with dimensions n×H×W comes as output tensor 414A with dimensions out×H/2×W/2.

Block 400B is an up-conversion block where input tensor 402 with dimensions n×H×W comes as output tensor 414B with dimensions out×2·H×2·W, after up-sampling operation 403C.

Block 400C is a convolution block that maintains the 2D dimensionality of input block 402, but may change the number of frames (and their content). An output tensor 414C has dimensions out×H×W.

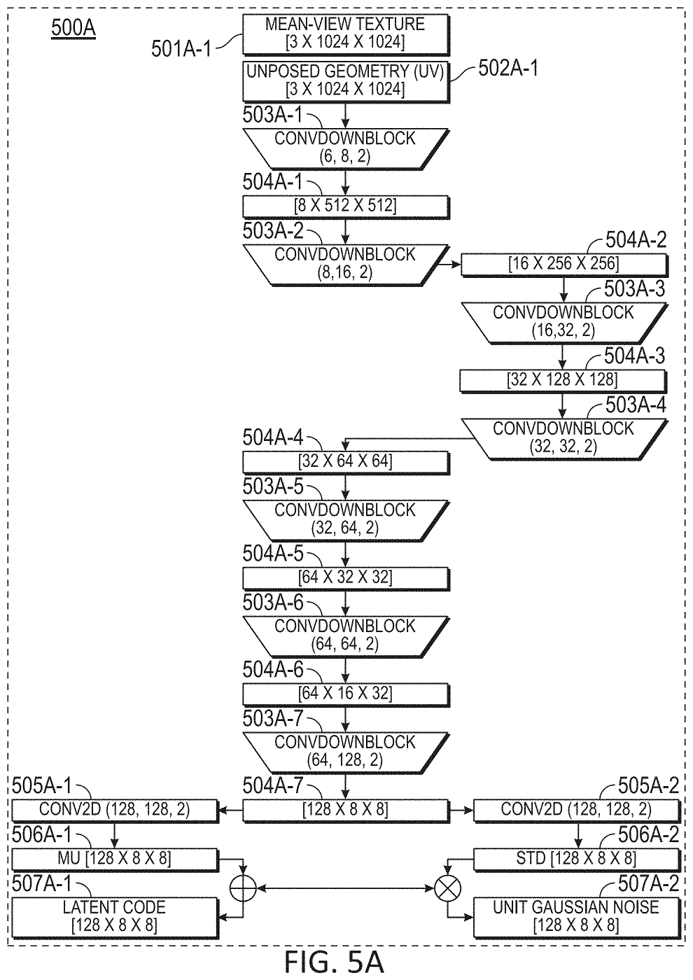

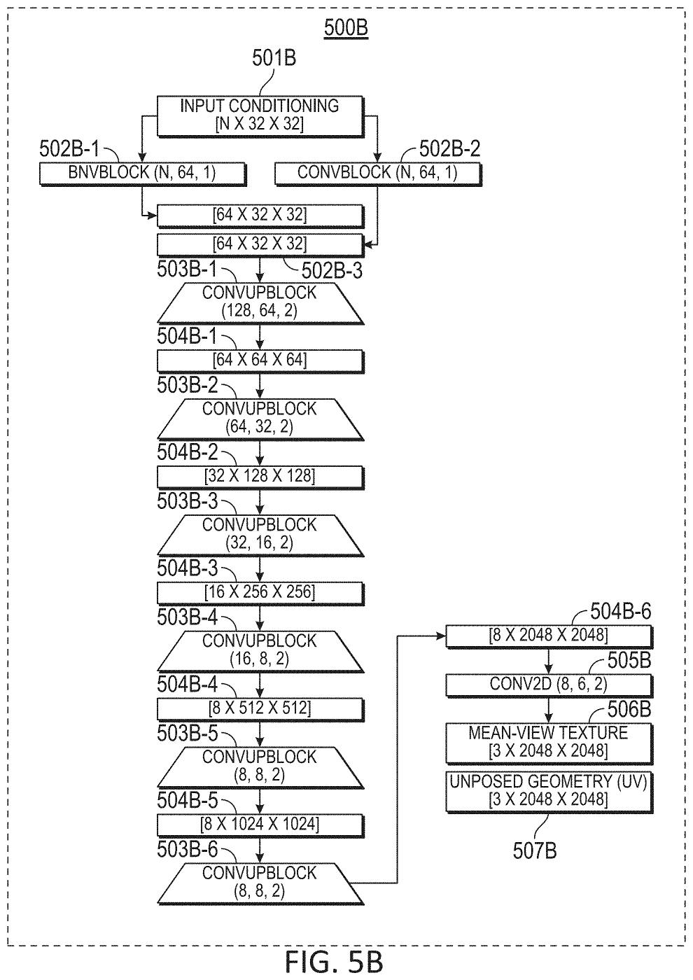

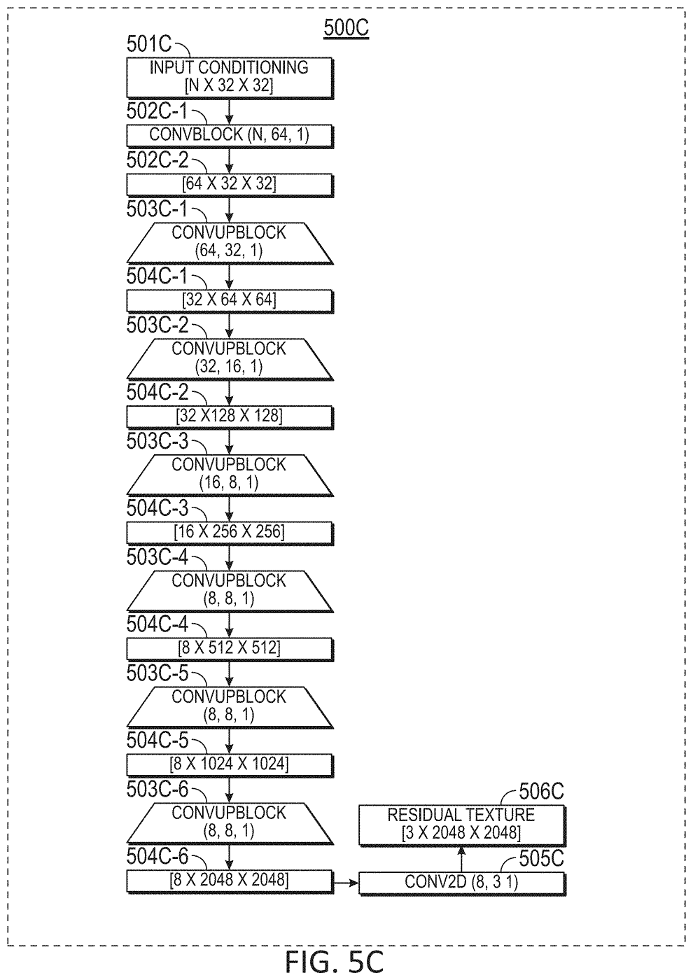

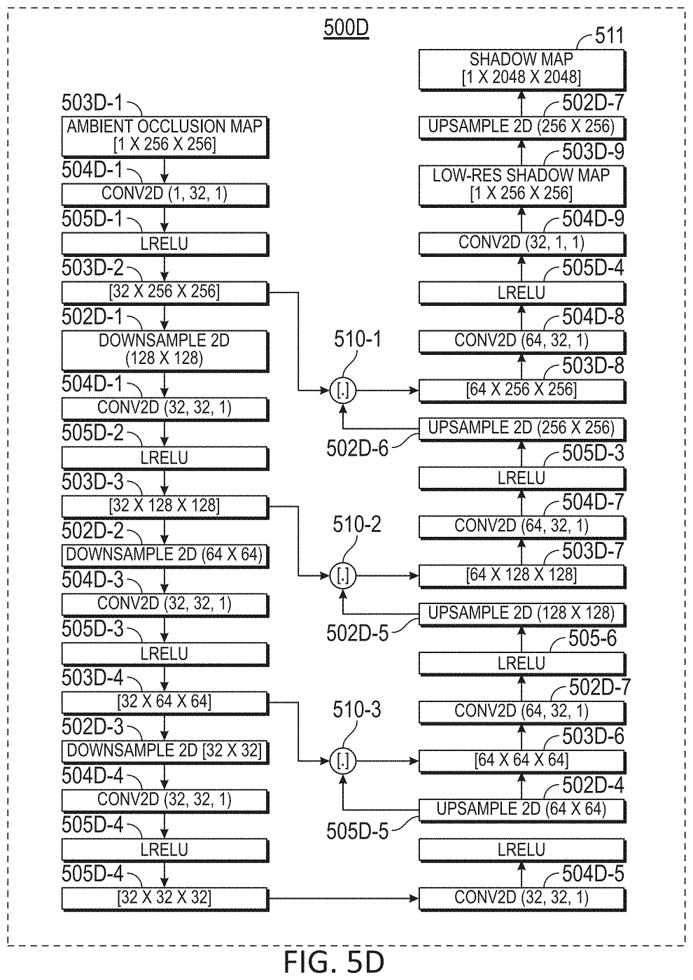

FIG. 5 illustrates encoder 500A, decoders 500B and 500C, and shadow network 500D architectures for use in a real-time, clothed subject animation model, according to some embodiments (hereinafter, collectively referred to as “architectures 500”).

Encoder 500A includes input tensors 501A-1, and down-conversion blocks 503A-1, 503A-2, 503A-3, 503A-4, 503A-5, 503A-6, and 503A-7 (hereinafter, collectively referred to as “down-conversion blocks 503A”), acting on tensors 502A-1, 504A-1, 504A-2, 504A-3, 504A-4, 504A-5, 504A-6, and 504A-7, respectively. Convolution blocks 505A-1 and 505A-2 (hereinafter, collectively referred to as “convolution blocks 505A”) convert tensor 504A-7 into a tensor 506A-1 and a tensor 506A-2 (hereinafter, collectively referred to as “tensors 506A”). Tensors 506A are combined into latent code 507A-1 and a noise block 507A-2 (collectively referred to, hereinafter, as “encoder outputs 507A”). Note that, in the particular example illustrated, encoder 500A takes input tensor 501A-1 including, e.g., 8 image frames with pixel dimensions 1024×1024 and produces encoder outputs 507A with 128 frames of size 8×8.

Decoder 500B includes convolution blocks 502B-1 and 502B-2 (hereinafter, collectively referred to as “convolution blocks 502”), acting on input tensor 501B to form a tensor 502B-3. Up-conversion blocks 503B-1, 503B-2, 503B-3, 503B-4, 503B-5, and 503B-6 (hereinafter, collectively referred to as “up-conversion blocks 503B”) act upon tensors 504B-1, 504B-2, 504B-3, 504B-4, 504B-5, and 504B-6 (hereinafter, collectively referred to as “tensors 504B”). A convolution 505B acting on tensor 504B-6 produces a texture tensor 506B and a geometry tensor 507B.

Decoder 500C includes convolution block 502C-1 acting on input tensor 501C to form a tensor 502C-2. Up-conversion blocks 503C-1, 503C-2, 503C-3, 503C-4, 503C-5, and 503C-6 (hereinafter, collectively referred to as “up-conversion blocks 503C”) act upon tensors 502C-2, 504C-1, 504C-2, 504C-3, 504C-4, 504C-5, and 504C-6 (hereinafter, collectively referred to as “tensors 504C”). A convolution 505C acting on tensor 504C produces a texture tensor 506C.

Shadow network 500D includes convolution blocks 504D-1, 504D-2, 504D-3, 504D-4, 504D-5, 504D-6, 504D-7, 504D-8, and 504D-9 (hereinafter, collectively referred to as “convolution blocks 504D”), acting upon tensors 503D-1, 503D-2, 503D-3, 503D-4, 503D-5, 503D-6, 503D-7, 503D-8, and 503D-9 (hereinafter, collectively referred to a “tensors 503D”), after down sampling 502D-1 and 502D-2, and up-sampling 502D-3, 502D-4, 502D-5, 502D-6, and 502D-7 (hereinafter, collectively referred to as “up and down-sampling operations 502D”), and after LReLU operations 505D-1, 505D-2, 505D-3, 505D-4, 505D-5 and 505D-6 (hereinafter, collectively referred to as “LReLU operations 505D”). At different stages along shadow network 500D, concatenations 510-1, 510-2, and 510-3 (hereinafter, collectively referred to as “concatenations 610”) join tensor 503D-2 to tensor 503D-8, tensor 503D-3 to tensor 503D-7, and tensor 503D-4 to tensor 503D-6. The output of shadow network 500D is shadow map 511.

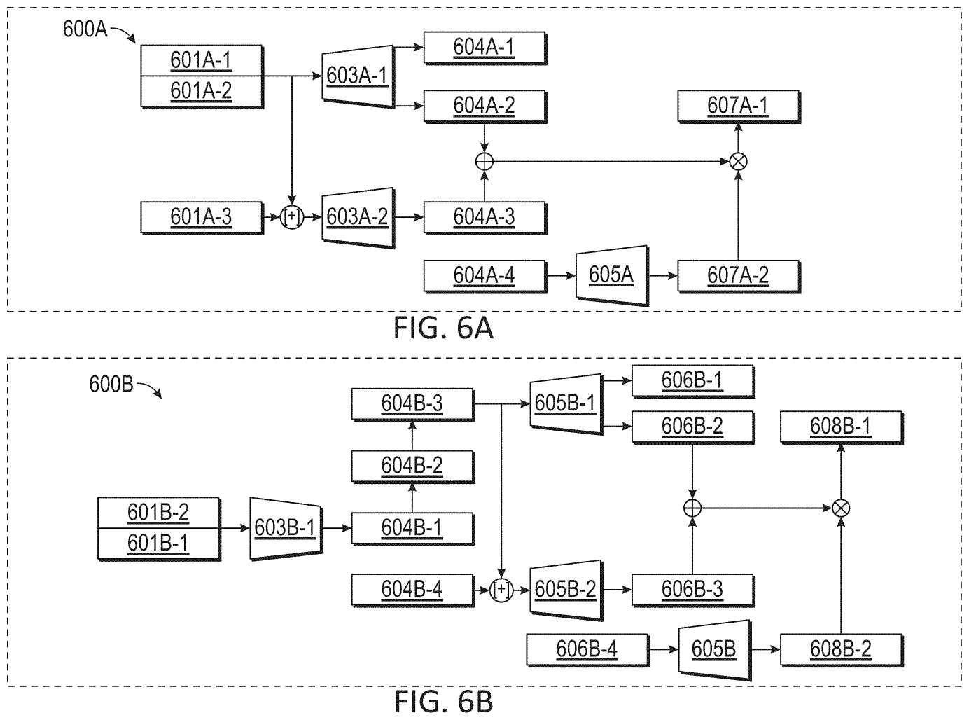

FIGS. 6A-6B illustrate architectures of a body network 600A and a clothing network 600B (hereinafter, collectively referred to as “networks 600”) for a real-time, clothed subject animation model, according to some embodiments. Once the clothing is decoupled from the body, the skeletal pose and facial keypoints contain sufficient information to describe the body state (including pants that are relatively tight).

Body network 600A takes in the skeletal pose 601A-1, facial keypoints 601A-2, and view-conditioning 601A-3 as input (hereinafter, collectively referred to as “inputs 601A”) to up-conversion blocks 603A-1 (view-independent) and 603A-2 (view-dependent), hereinafter, collectively referred to as “decoders 603A,” produces unposed geometry in a 2D, UV coordinate map 604A-1, body mean-view texture 604A-2, body residue texture 604A-3, and body ambient occlusion 604A-4. Body mean-view texture 604A-2 is compounded with body residual texture 604A-3 to generate body texture 607A-1 for the body as output. An LBS transformation is then applied in shadow network 605A (cf shadow network 500D) to the unposed mesh restored from the UV map to produce the final output mesh 607A-2. The loss function to train the body network is defined as:

Eₜᵣₐᵢₙ^{B}=λ_{g}∥V_{B}^{p}−V_{B}^{r}∥²+λₗₐₚ∥L(V_{B}^{p})−L(V_{B}^{r}∥²+λₜ∥(T_{B}^{p}−T_{B}^{t})⊙M_{B}^{V}∥² (9)

where V^{p}_{B} is the vertex position interpolated from the predicted position map in UV coordinates, and V^{τ}_{B} is the vertex from inner layer registration. L(•) is the Laplacian operator, T^{p}_{B} is the predicted texture, T^{t}_{B} is the reconstructed texture per-view, and M^{v}_{B} is the mask indicating the valid UV region.

Clothing network 600B includes a Conditional Variational Autoencoder (cVAE) 603B-1 that takes as input an unposed clothing geometry 601B-1 and a mean-view texture 601B-2 (hereinafter, collectively referred to as “clothing inputs 601B”), and produces parameters of a Gaussian distribution, from which a latent code 604B-1 (z) is up-sampled in block 604B-2 to form a latent conditioning tensor 604B-3. In addition to latent conditioning tensor 604B-3, cVAE 603B-1 generates a spatial-varying view conditioning tensor 604B-4 as inputs to view-independent decoder 605B-1 and view-dependent decoder 605B-2, and predicts clothing geometry 606B-1, clothing texture 606B-2, and clothing residual texture 606B-3. A training loss can be described as:

Eₜᵣₐᵢₙ^{c}=λ_{g}∥V_{C}^{p}−V_{C}^{r}∥²+λₗₐₚ∥L(V_{C}^{p})−L(V_{C}^{r}∥²+λₜ∥(T_{C}^{p}−T_{c}^{t})⊙M_{C}^{V}∥²+λₖₗEₖₗ (10)

where V^{p}_{B} is the vertex position for the clothing geometry 606B-1 interpolated from the predicted position map in UV coordinates, and V^{r}_{B} is the vertex from inner layer registration. An L(•), is the Laplacian operator, T^{p}_{B} is predicted texture 606B-2, T^{t}_{B} is the reconstructed texture per-view 608B-1, and M^{V}_{B} is the mask indicating the valid UV region. And Eₖₗ is a Kullbar-Leibler (KL) divergence loss. A shadow network 605B (cf. shadow networks 500D and 605A) uses clothing template 606B-4 to form a clothing shadow map 608B-2.

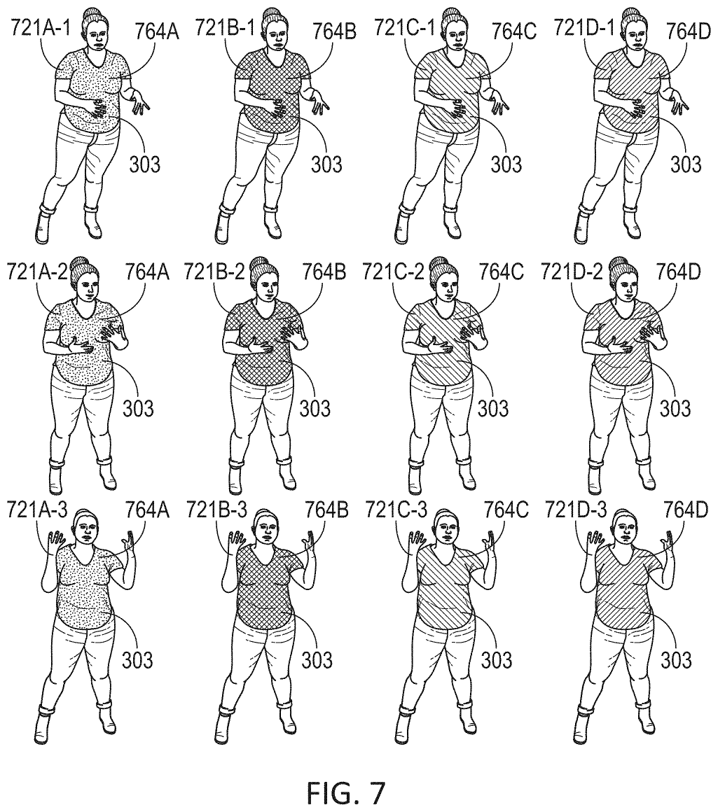

FIG. 7 illustrates texture editing results of a two-layer model for providing a real-time, clothed subject animation, according to some embodiments. Avatars 721A-1, 721A-2, and 721A-3 (hereinafter, collectively referred to as “avatars 721A”) correspond to three different poses of subject 303, and using a first set of clothes 764A. Avatars 721B-1, 721B-2, and 721B-3 (hereinafter, collectively referred to as “avatars 721B”) correspond to three different poses of subject 303, and using a second set of clothes 764B. Avatars 721C-1, 721C-2, and 721C-3 (hereinafter, collectively referred to as “avatars 721C”) correspond to three different poses of subject 303, and using a first set of clothes 764C. Avatars 721D-1, 721D-2, and 721D-3 (hereinafter, collectively referred to as “avatars 721D”) correspond to three different poses of subject 303, and using a first set of clothes 764D.

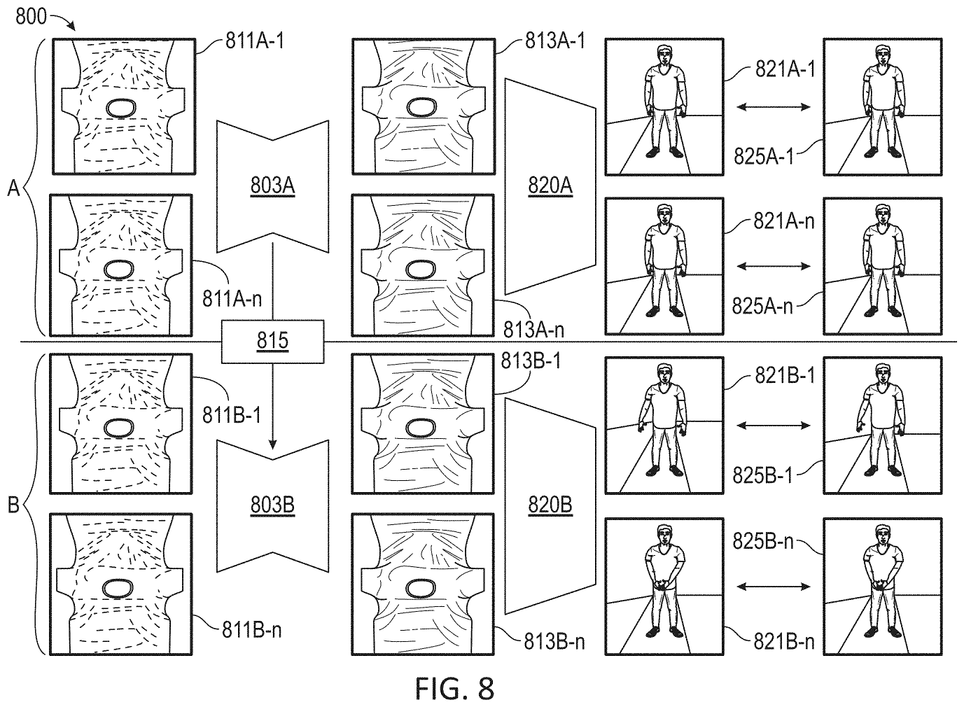

FIG. 8 illustrates an inverse-rendering-based photometric alignment method 800, according to some embodiments. Method 800 corrects correspondence errors in the registered body and clothing meshes (e.g., meshes 321), which significantly improves decoder quality, especially for the dynamic clothing. Method 800 is a network training stage that links predicted geometry (e.g., body geometry 604A-1 and clothing geometry 606B-1) and texture (e.g., body texture 604A-2 and clothing texture 606B-2) to the input multi-view images (e.g., images 301) in a differentiable way. To this end, method 800 jointly trains body and clothing networks (e.g., networks 600) including a VAE 803A and, after an initialization 815, a VAE 803B (hereinafter, collectively referred to hereinafter as “VAEs 803.”). VAEs 803 render the output with a differentiable renderer. In some embodiments, method 800 uses the following loss function:

Eₜᵣₐᵢₙ^{inv}=λᵢ∥I^{R}−I^{C}∥+λₘ∥M^{R}−M^{C}∥30 λᵥE_{softvisi}+λₗₐₚEₗₐₚ (11)

where I^{R} and I^{C} are the rendered image and the captured image, M^{R} and M^{C} are the rendered foreground mask and the captured foreground meshes, and Eₗₐₚ is the Laplacian geometry loss (cf. Eqs. 9 and 10). E_{softvisi} is a soft visibility loss, that handles a depth reasoning between the body and clothing so that the gradient can be back-propagated through, to correct the depth order. In detail, we define the soft visibility for a specific pixel as:

$$S = σ ( \frac{{D}^{C} - {D}^{B}}{c} ) \qquad ( 12 )$$

where σ(•) is the sigmoid function, D^{C} and D^{B} are the depth rendered from the current viewpoint for the clothing and body layer, and c is a scaling constant. Then the soft visibility loss is defined as:

E_{softvisi}=S² (13)

when S>0.5 and a current pixel is assigned to be clothing according to a 2D cloth segmentation. Otherwise, E_{softvisi} is set to 0.

In some embodiments, method 800 may improve photometric correspondences by predicting texture with less variance across frames, along with deformed geometry to align the rendering output with the ground truth images. In some embodiments, method 800 trains VAEs 803 simultaneously, using an inverse rendering loss (cf. Eqs. 11-13) and corrects the correspondences while creating a generative model for driving real-time animation. To find a good minimum, method 800 desirably avoids large variation in photometric correspondences in initial meshes 821. Also, method 800 desirably avoids VAEs 803 adjusting view-dependent textures to compensate for geometry discrepancies, which may create artifacts.

To resolve the above challenges, method 800 separates input anchor frames (A), 811A-1 through 811A-n (hereinafter, collectively referred to as “input anchor frames 811A”) into chunks (B) of 50 neighboring frames: input chunk frames 811B-1 through 811B-n (hereinafter, collectively referred to as “input chunk frames 811B”). Method 800 uses input anchor frames 811A to train a VAE 803A to obtain aligned anchor frames 813A-1 through 813A-n (hereinafter, collectively referred to as “aligned anchor frames 813A”). And method 800 uses chunk frames 811B to train VAE 803B to obtain aligned chunk frames 813B-1 through 813B-n (hereinafter, collectively referred to as “aligned chunk frames 813B”). In some embodiments, method 800 selects the first chunk 811B-1 as an anchor frame 811A-1, and trains VAEs 803 for this chunk. After convergence, the trained network parameters initialize the training of other chunks (B). To avoid drifting of the alignment of chunks B from anchor frames A, method 800 may set a small learning rate (e.g., 0.0001 for an optimizer), and mix anchor frames A with each other chunk B, during training. In some embodiments, method 800 uses a single texture prediction for inverse rendering in one or more, or all, of the multi-views from a subject. Aligned anchor frames 813A and aligned chunk frames 813B (hereinafter, collectively referred to as “aligned frames 813”) have more consistent correspondences across frames compared to input anchor frames 811A and input chunk frames 811B. In some embodiments, aligned meshes 825 may be used to train a body network and a clothing network (cf. networks 600).

Method 800 applies a photometric loss (cf. Eqs. 11-13) to a differentiable renderer 820A to obtain aligned meshes 825A-1 through 825A-n (hereinafter, collectively referred to as “aligned meshes 825A”), from initial meshes 821A-1 through 821A-n (hereinafter, collectively referred to as “initial meshes 821A”), respectively. A separate VAE 803B is initialized independently from VAE 803A. Method 800 uses input chunk frames 811B to train VAE 803B to obtain aligned chunk frames 813B. Method 800 applies the same loss function (cf. Eqs. 11-13) to a differentiable renderer 820B to obtain aligned meshes 825B-1 through 825B-n (hereinafter, collectively referred to as “aligned meshes 825B”), from initial meshes 821B-1 through 821B-n (hereinafter, collectively referred to as “initial meshes 821B”), respectively.

When a pixel is labeled as “clothing” but the body layer is on top of the clothing layer from this viewpoint, the soft visibility loss will back-propagate the information to update the surfaces until the correct depth order is achieved. In this inverse rendering stage, we also use a shadow network that computes quasi-shadow maps for body and clothing given the ambient occlusion maps. In some embodiments, method 800 may approximate an ambient occlusion with the body template after the LBS transformation. In some embodiments, method 800 may compute the exact ambient occlusion using the output geometry from the body and clothing decoders to model a more detailed clothing deformation than can be gleaned from an LBS function on the body deformation. The quasi-shadow maps are then multiplied with the view-dependent texture before applying differentiable renderers 820.

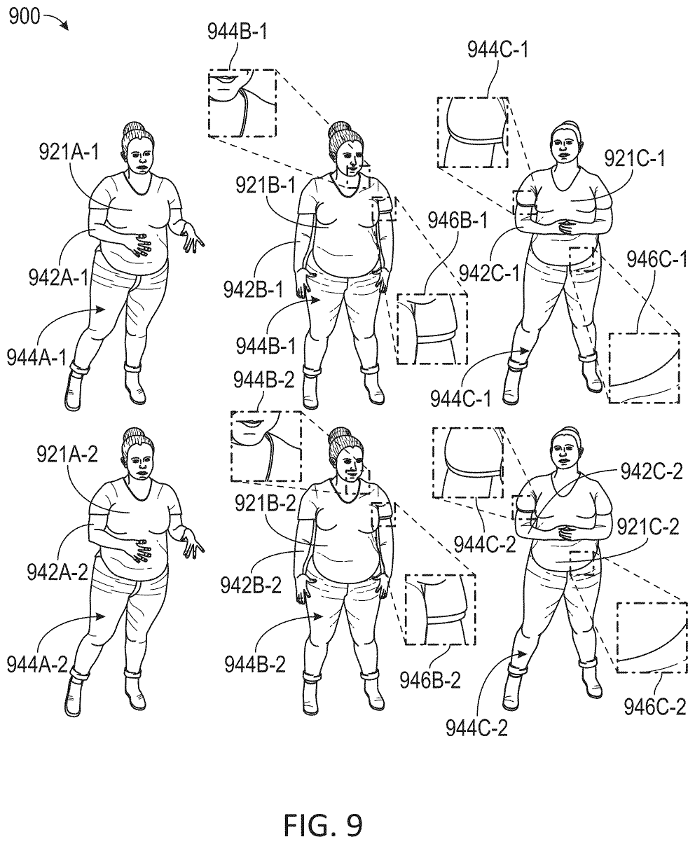

FIG. 9 illustrates a comparison of a real-time, three-dimensional clothed model 900 of a subject between single-layer neural network models 921A-1, 921B-1, and 921C-1 (hereinafter, collectively referred to as “single-layer models 921-1”) and a two-layer neural network model 921A-2, 921B-2, and 921C-2 (hereinafter, collectively referred to as “two-layer models 921-2”), in different poses A, B, and C (e.g., a time-sequence of poses), according to some embodiments. Network models 921 include body outputs 942A-1, 942B-1, and 942C-1 (hereinafter, collectively referred to as “single-layer body outputs 942-1”) and body outputs 942A-2, 942B-2, and 942C-2 (hereinafter, collectively referred to as “body outputs 942-2”). Network models 921 also include clothing outputs 944A-1, 944B-1, and 944C-1 (hereinafter, collectively referred to as “single-layer clothing outputs 944-1”) and clothing outputs 944A-2, 944B-2, and 944C-2 (hereinafter, collectively referred to as “two-layer clothing outputs 944-2”), respectively.

Two-layer body outputs 942-2 are conditioned on a single frame of skeletal pose and facial keypoints, and two-layer clothing outputs 944-2 are determined by a latent code. To animate the clothing between frames A, B, and C, model 900 includes a temporal convolution network (TCN) to learn the correlation between body dynamics and clothing deformation. The TCN takes in a time sequence (e.g., A, B, and C) of skeletal poses and infers a latent clothing state. The TCN takes as input joint angles, θi, in a window of L frames leading up to a target frame, and passes through several one-dimensional (1D) temporal convolution layers to predict the clothing latent code for a current frame, C (e.g., two-layer clothing output 944C-2). To train the TCN, model 900 minimizes the following loss function:

Eₜᵣₐᵢₙ^{TCN}=∥Z−Z^{C}∥² (14)

where zc is the ground truth latent code obtained from a trained clothing VAE (e.g., cVAE 603B-1). In some embodiments, model 900 conditions the prediction on not just previous body states, but also previous clothing states. Accordingly, clothing vertex position and velocity in the previous frame (e.g., poses A and B) are needed to compute the current clothing state (pose C). In some embodiments, the input to the TCN is a temporal window of skeletal poses, not including previous clothing states. In some embodiments, model 900 includes a training loss for TCN to ensure that the predicted clothing does not intersect with the body. In some embodiments, model 900 resolves intersection between two-layer body outputs 942-2 and two-layer clothing outputs 944-2 as a post processing step. In some embodiments, model 900 projects intersecting two-layer clothing outputs 944-2 back onto the surface of two-layer body outputs 942-2 with an additional margin in the normal body direction. This operation will solve most intersection artifacts and ensure that two-layer clothing outputs 942-2 and two-layer body outputs 942-2 are in the right depth order for rendering. Examples of intersection resolving issues may be seen in portions 944B-2 and 946B-2, for pose B, and portions 944C-2 and 946C-2 in pose C. By comparison, portions 944B-1 and 946B-1, for pose B, and portions 944C-1 and 946C-1 in pose C show intersection and blending artifacts between body outputs 942B-1 (942C-1) and clothing outputs 944B-1 (944C-1).

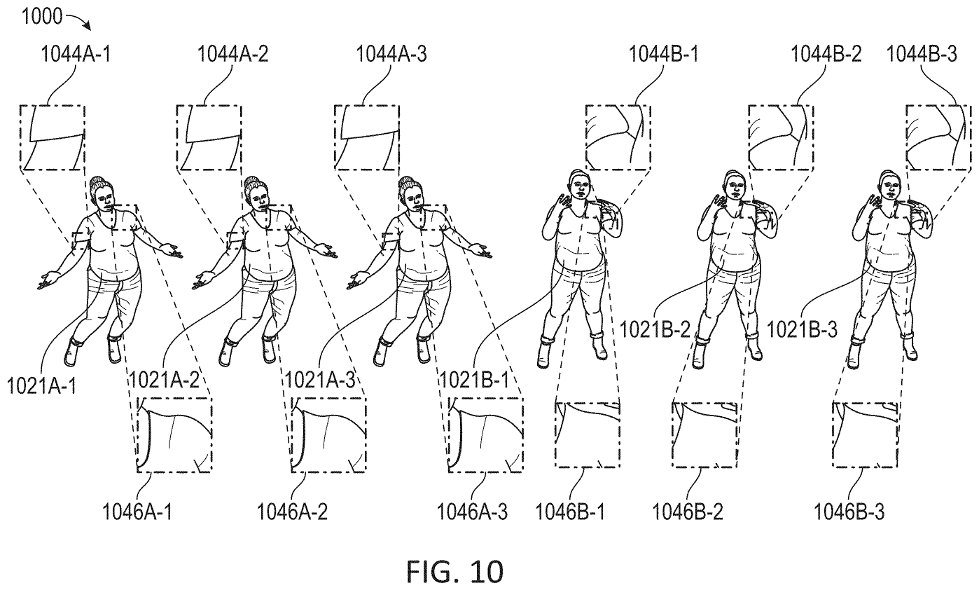

FIG. 10 illustrates animation avatars 1021A-1 (single-layer, without latent, pose A), 1021A-2 (single layer, with latent, pose A), 1021A-3 (double-layer, pose A), 1021B-1 (single-layer, without latent, pose B), 1021B-2 (single layer, with latent, pose B), and 1021B-3 (double-layer, pose B), for a real-time, three-dimensional clothed subject rendition model 1000, according to some embodiments.

Two-layer avatars 1021A-3 and 1021B-3 (hereinafter, collectively referred to as “two-layer avatars 1021-3”) are driven by 3D skeletal pose and facial keypoints. Model 1000 feeds skeletal pose and facial keypoints of a current frame (e.g., pose A or B) to a body decoder (e.g., body decoders 603A). A clothing decoder (e.g., clothing decoders 603B) is driven by latent clothing code (e.g., latent code 604B-1), via a TCN, which takes a temporal window of history and current poses as input. Model 1000 animates single-layer avatars 1021A-1, 1021A-2, 1021B-1, and 1021B-2 (hereinafter, collectively referred to as “single-layer avatars 1021-1 and 1021-2”) via random sampling of a unit Gaussian distribution (e.g., clothing inputs 604B), and use the resulting noise values for imputation of the latent code, where available. For the sampled latent code in avatars 1021A-2 and 1021-B-2, model 1000 feeds the skeletal pose and facial keypoints together, into the decoder networks (e.g., networks 600). Model 1000 removes severe artifacts in the clothing regions in the animation output, especially around the clothing boundaries, in two-layer avatars 1021-3. Indeed, as the body and clothing are modeled together, single-layer avatars 1021-1 and 1021-2 rely on the latent code to describe the many possible clothing states corresponding to the same body pose. During animation, the absence of a ground truth latent code leads to degradation of the output, despite the efforts to disentangle the latent space from the driving signal.

Two-layer avatars 1021-3 achieve better animation quality by separating body and clothing into different modules, as can be seen by comparing border areas 1044A-1, 1044A-2, 1044B-1, 1044B-2, 1046A-1, 1046A-2, 1046B-1 and 1046B-2 in single-layer avatars 1021-1 and 1021-2, with border areas 1044A-3, 1046A-3, 1044B-3 and 1046B-3 in two-layer avatars 1021-3 (e.g., areas that include a clothed portion and a naked body portion, hereinafter, collectively referred to as border areas 1044 and 1046). Accordingly, a body decoder (e.g., body decoders 603A) can determine the body states given the driving signal of the current frame, TCN learns to infer the most plausible clothing states from body dynamics for a longer period, and the clothing decoders (e.g., clothing decoders 605B) ensure a reasonable clothing output given its learned smooth latent manifold. In addition, two-layer avatars 1021-3 show results with a sharper clothing boundary and clearer wrinkle patterns in these qualitative images. A quantitative analysis of the animation output includes evaluating the output images against the captured ground truth images. Model 1000 may report the evaluation metrics in terms of a Mean Square Error (MSE) and a Structural Similarity Index Measure (SSIM) over the foreground pixels. Two-layer avatars 1021-3 typically outperform single-layer avatars 1021-1 and 1021-2 on all three sequences and both evaluation metrics.

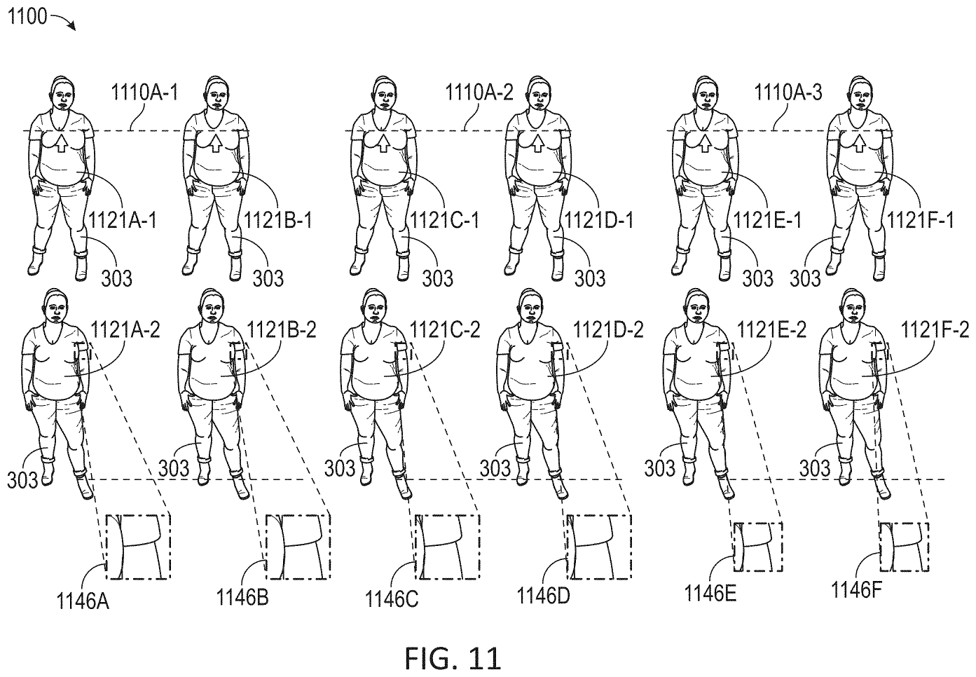

FIG. 11 illustrates a comparison 1100 of chance correlations between different real-time, three-dimensional clothed avatars 1121A-1, 1121B-1, 1121C-1, 1121D-1, 1121E-1, and 1121F-1 (hereinafter, collectively referred to as “avatars 1121-1”) for subject 303 in a first pose, and clothed avatars 1121A-2, 1121B-2, 1121C-2, 1121D-2, 1121E-2, and 1121F-2 (hereinafter, collectively referred to as “avatars 1121-1”) for subject 303 in a second pose, according to some embodiments.

Avatars 1121A-1, 1121D-1 and 1121A-2, 1121D-2 were obtained in a single-layer model without a latent encoding. Avatars 1121B-1, 1121E-1 and 1121B-2, 1121E-2 were obtained in a single-layer model using a latent encoding. And avatars 1121C-1, 1121F-1 and 1121C-2, 1121F-2 were obtained in a two-layer model.

Dashed lines 1110A-1, 1110A-2, and 1110A-3 (hereinafter, collectively referred to as “dashed lines 1110A”) indicate a change in clothing region in subject 303 around areas 1146A, 1146B, 1146C, 1146D, 1146E, and 1146F (hereinafter, collectively referred to as “border areas 1146”).

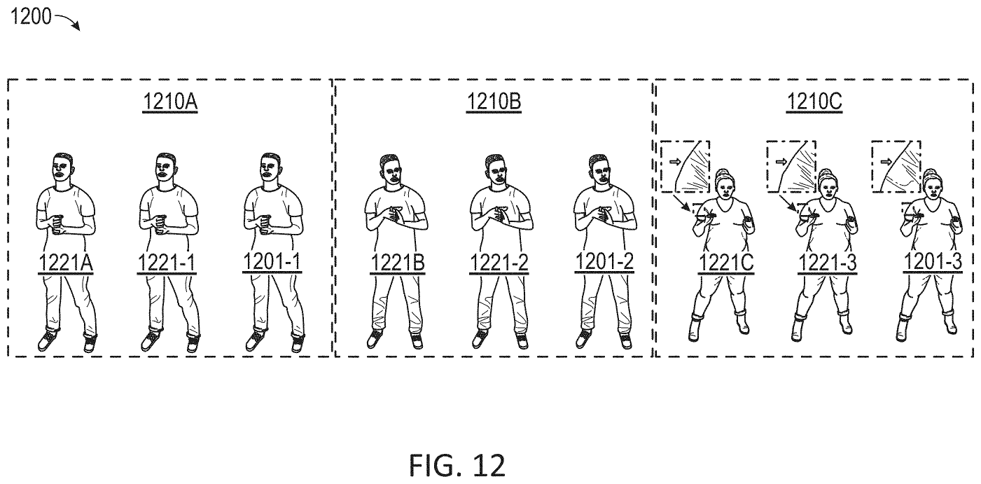

FIG. 12 illustrates an ablation analysis for a direct clothing modeling 1200, according to some embodiments. Frame 1210A illustrates avatar 1221A obtained by model 1200 without a latent space, avatar 1221-1 obtained with model 1200 including a two-layer network, and the corresponding ground truth image 1201-1. Avatar 1221A is obtained directly regressing clothing geometry and texture from a sequence of skeleton poses as input. Frame 1210B illustrates avatar 1221B obtained by model 1200 without a texture alignment step with a corresponding ground-truth image 1201-2, compared with avatar 1221-2 in a model 1200 including a two-layer network. Avatars 1221-1 and 1221-2 show sharper texture patterns. Frame 1210C illustrates avatar 1221C obtained with model 1200 without view-conditioning effects. Notice the strong reflectance of lighting near the subject's silhouette in avatar 1221-3 obtained with model 1200 including view-conditioning steps.

One alternative for this design is to combine the functionalities of the body and clothing networks (e.g., networks 600) as one: to train a decoder that takes a sequence of skeleton poses as input and predicts clothing geometry and texture as output (e.g., avatar 1221-1). Avatar 1221A is blurry around the logo region, near the subject's chest. Indeed, even a sequence of skeleton poses does not contain enough information to fully determine the clothing state. Therefore, directly training a regressor from the information-deficient input (e.g., without latent space) to final clothing output leads to underfitting to the data by the model. By contrast, model 1200 including the two-layer networks can model different clothing states in detail with a generative latent space, while the temporal modeling network infers the most probable clothing state. In this way, a two-layered network can produce high-quality animation output with sharp detail.

Model 1200 generates avatar 1221-2 by training on registered body and clothing data with texture alignment, against a baseline model trained on data without texture alignment (avatar 1221B). Accordingly, photometric texture alignment helps to produce sharper detail in the animation output, as the better texture alignment makes the data easier for the network to digest. In addition, avatar 1221-3 from model 1200 including a two-layered network includes view-dependent effects and is visually more similar to ground truth 1201-3 than avatar 1221C, without texture alignment. The difference is observed near the silhouette of the subject, where avatar 1221-3 is brighter due to Fresnel reflectance when the incidence angle gets close to 90, a factor that makes the view-dependent output more photo-realistic. In some embodiments, temporal model tends to produce output with jittering with a small temporal window. Longer temporal windows in TCN achieves a desirable tradeoff between visual temporal consistency and model efficiency.

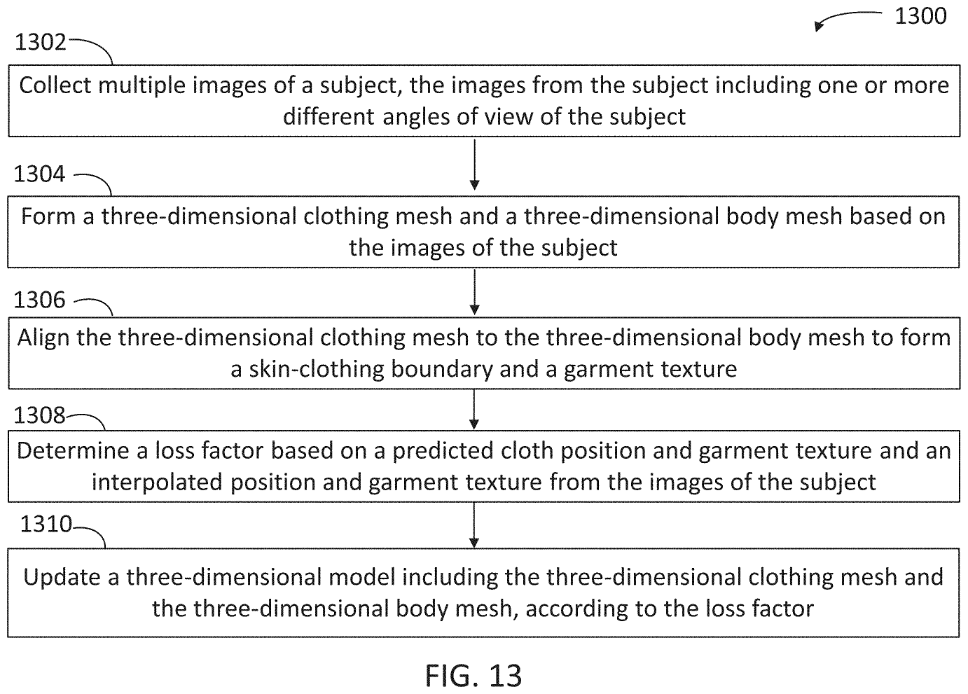

FIG. 13 is a flow chart illustrating steps in a method 1300 for training a direct clothing model to create real-time subject animation from binocular video, according to some embodiments. In some embodiments, method 1300 may be performed at least partially by a processor executing instructions in a client device or server as disclosed herein (cf. processors 212 and memories 220, client devices 110, and servers 130). In some embodiments, at least one or more of the steps in method 1300 may be performed by an application installed in a client device, or a model training engine including a clothing animation model (e.g., application 222, model training engine 232, and clothing animation model 240). A user may interact with the application in the client device via input and output elements and a GUI, as disclosed herein (cf. input device 214, output device 216, and GUI 225). The clothing animation model may include a body decoder, a clothing decoder, a segmentation tool, and a time convolution tool, as disclosed herein (e.g., body decoder 242, clothing decoder 244, segmentation tool 246, and time convolution tool 248). In some embodiments, methods consistent with the present disclosure may include at least one or more steps in method 1300 performed in a different order, simultaneously, quasi-simultaneously, or overlapping in time.

Step 1302 includes collecting multiple images of a subject, the images from the subject including one or more different angles of view of the subject.

Step 1304 includes forming a three-dimensional clothing mesh and a three-dimensional body mesh based on the images of the subject.

Step 1306 includes aligning the three-dimensional clothing mesh to the three-dimensional body mesh to form a skin-clothing boundary and a garment texture.

Step 1308 includes determining a loss factor based on a predicted cloth position and garment texture and an interpolated position and garment texture from the images of the subject.

Step 1310 includes updating a three-dimensional model including the three-dimensional clothing mesh and the three-dimensional body mesh, according to the loss factor.

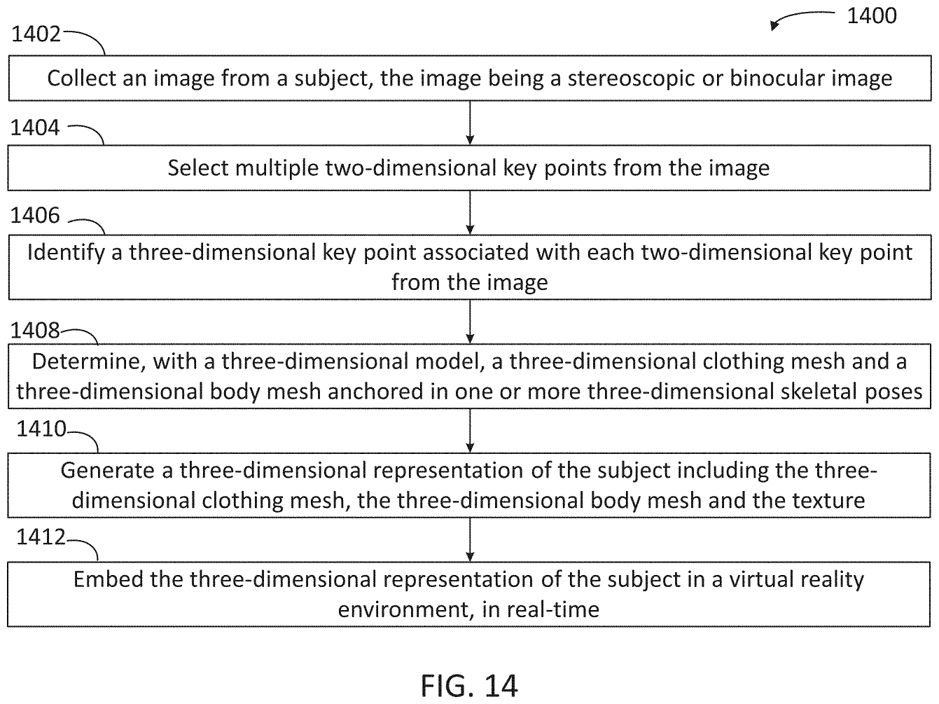

FIG. 14 is a flow chart illustrating steps in a method 1400 for embedding a real-time, clothed subject animation in a virtual reality environment, according to some embodiments. In some embodiments, method 1400 may be performed at least partially by a processor executing instructions in a client device or server as disclosed herein (cf. processors 212 and memories 220, client devices 110, and servers 130). In some embodiments, at least one or more of the steps in method 1400 may be performed by an application installed in a client device, or a model training engine including a clothing animation model (e.g., application 222, model training engine 232, and clothing animation model 240). A user may interact with the application in the client device via input and output elements and a GUI, as disclosed herein (cf. input device 214, output device 216, and GUI 225). The clothing animation model may include a body decoder, a clothing decoder, a segmentation tool, and a time convolution tool, as disclosed herein (e.g., body decoder 242, clothing decoder 244, segmentation tool 246, and time convolution tool 248). In some embodiments, methods consistent with the present disclosure may include at least one or more steps in method 1400 performed in a different order, simultaneously, quasi-simultaneously, or overlapping in time.

Step 1402 includes collecting an image from a subject. In some embodiments, step 1402 includes collecting a stereoscopic or binocular image from the subject. In some embodiments, step 1402 includes collecting multiple images from different views of the subject, simultaneously or quasi simultaneously.

Step 1404 includes selecting multiple two-dimensional key points from the image.

Step 1406 includes identifying a three-dimensional skeletal pose associated with each two-dimensional key point in the image.

Step 1408 includes determining, with a three-dimensional model, a three-dimensional clothing mesh and a three-dimensional body mesh anchored in one or more three-dimensional skeletal poses.

Step 1410 includes generating a three-dimensional representation of the subject including the three-dimensional clothing mesh, the three-dimensional body mesh and the texture.

Step 1412 includes embedding the three-dimensional representation of the subject in a virtual reality environment, in real-time.

### Hardware Overview

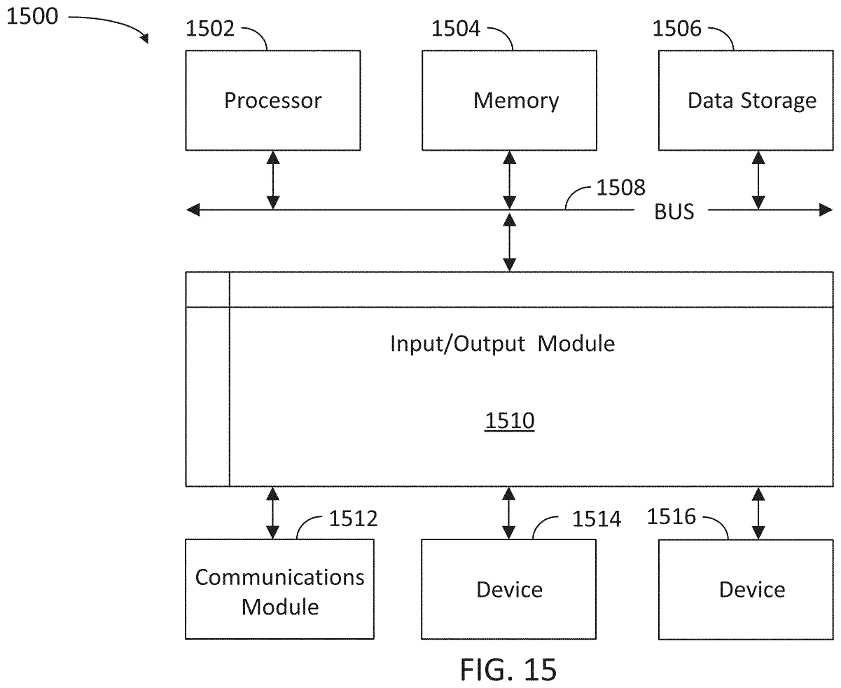

FIG. 15 is a block diagram illustrating an exemplary computer system 1500 with which the client and server of FIGS. 1 and 2, and the methods of FIGS. 13 and 14 can be implemented. In certain aspects, the computer system 1500 may be implemented using hardware or a combination of software and hardware, either in a dedicated server, or integrated into another entity, or distributed across multiple entities.

Computer system 1500 (e.g., client 110 and server 130) includes a bus 1508 or other communication mechanism for communicating information, and a processor 1502 (e.g., processors 212) coupled with bus 1508 for processing information. By way of example, the computer system 1500 may be implemented with one or more processors 1502. Processor 1502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1500 can include, in addition to hardware, code that creates an execution environment for the computer program in question, e.g., code that constitutes processor firmware, a protocol stack, a database management system, an operating system, or a combination of one or more of them stored in an included memory 1504 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1508 for storing information and instructions to be executed by processor 1502. The processor 1502 and the memory 1504 can be supplemented by, or incorporated in, special purpose logic circuitry.

The instructions may be stored in the memory 1504 and implemented in one or more computer program products, e.g., one or more modules of computer program instructions encoded on a computer-readable medium for execution by, or to control the operation of, the computer system 1500, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1504 may also be used for storing temporary variable or other intermediate information during execution of instructions to be executed by processor 1502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1500 further includes a data storage device 1506 such as a magnetic disk or optical disk, coupled to bus 1508 for storing information and instructions. Computer system 1500 may be coupled via input/output module 1510 to various devices. Input/output module 1510 can be any input/output module. Exemplary input/output modules 1510 include data ports such as USB ports. The input/output module 1510 is configured to connect to a communications module 1512. Exemplary communications modules 1512 (e.g., communications modules 218) include networking interface cards, such as Ethernet cards and modems. In certain aspects, input/output module 1510 is configured to connect to a plurality of devices, such as an input device 1514 (e.g., input device 214) and/or an output device 1516 (e.g., output device 216). Exemplary input devices 1514 include a keyboard and a pointing device, e.g., a mouse or a trackball, by which a user can provide input to the computer system 1500. Other kinds of input devices 1514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 1516 include display devices, such as an LCD (liquid crystal display) monitor, for displaying information to the user.

According to one aspect of the present disclosure, the client 110 and server 130 can be implemented using a computer system 1500 in response to processor 1502 executing one or more sequences of one or more instructions contained in memory 1504. Such instructions may be read into memory 1504 from another machine-readable medium, such as data storage device 1506. Execution of the sequences of instructions contained in main memory 1504 causes processor 1502 to perform the process steps described herein. One or more processors in a multi-processing arrangement may also be employed to execute the sequences of instructions contained in memory 1504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back-end component, e.g., a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following tool topologies, including a bus network, a star network, a ring network, a mesh network, a star-bus network, tree or hierarchical network, or the like. The communications modules can be, for example, modems or Ethernet cards.

Computer system 1500 can include clients and servers. A client and server are generally remote from each other and typically interact through a communication network. The relationship of client and server arises by virtue of computer programs running on the respective computers and having a client-server relationship to each other. Computer system 1500 can be, for example, and without limitation, a desktop computer, laptop computer, or tablet computer. Computer system 1500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1502 for execution. Such a medium may take many forms, including, but not limited to, non-volatile media, volatile media, and transmission media. Non-volatile media include, for example, optical or magnetic disks, such as data storage device 1506. Volatile media include dynamic memory, such as memory 1504. Transmission media include coaxial cables, copper wire, and fiber optics, including the wires forming bus 1508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is directly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method, comprising:
collecting multiple images of a subject, the images from the subject including one or more different angles of view of the subject;
forming a three-dimensional clothing mesh and a three-dimensional body mesh based on the images of the subject;
aligning the three-dimensional clothing mesh to the three-dimensional body mesh to form a skin-clothing boundary and a garment texture;
determining a loss factor based on a predicted cloth position and garment texture and an interpolated position and garment texture from the images of the subject; and
updating a three-dimensional model including the three-dimensional clothing mesh and the three-dimensional body mesh according to the loss factor.

2. The computer-implemented method of claim 1, wherein collecting multiple images of a subject comprises capturing the images from the subject with a synchronized multi-camera system.

3. The computer-implemented method of claim 1, wherein forming a three-dimensional body mesh comprises:
determining a skeletal pose from the images of the subject; and
adding a skinning mesh with a surface deformation to the skeletal pose.

4. The computer-implemented method of claim 1, wherein forming a three-dimensional body mesh comprises identifying exposed skin portions of the subject from the images of the subject as part of the three-dimensional body mesh.

5. The computer-implemented method of claim 1, wherein forming a three-dimensional clothing mesh comprises identifying a vertex in the three-dimensional clothing mesh by verifying that a projection of the vertex belongs to a clothing segment on each camera view.

6. The computer-implemented method of claim 1, wherein aligning the three-dimensional clothing mesh to the three-dimensional body mesh comprises selecting and aligning a clothing segment from the three-dimensional clothing mesh and a body segment from the three-dimensional body mesh.

7. The computer-implemented method of claim 1, wherein forming a three-dimensional clothing mesh and a three-dimensional body mesh comprises detecting one or more two-dimensional key points from the images of the subject; and triangulating multiple images from different points of view to convert the two-dimensional key points into three-dimensional key points that form the three-dimensional body mesh or the three-dimensional clothing mesh.

8. The computer-implemented method of claim 1, wherein aligning the three-dimensional clothing mesh to the three-dimensional body mesh comprises aligning the three-dimensional clothing mesh to a first template and aligning the three-dimensional body mesh to a second template, an selecting an explicit constraint to differentiate the first template from the second template.

9. The computer-implemented method of claim 1, further comprising animating the three-dimensional model using a temporal encoder for multiple skeletal poses and correlating each skeletal pose with a three-dimensional clothing mesh.

10. The computer-implemented method of claim 1, further comprising determining an animation loss factor based on multiple frames of a three-dimensional clothing mesh concatenated over a preselected time window as predicted by an animation model and as derived from the images over the preselected time window, and updating the animation model based on the animation loss factor.

11. A system, comprising:
a memory storing multiple instructions; and
one or more processors configured to execute the instructions to cause the system to:
collect multiple images of a subject, the images from the subject comprising one or more views from different profiles of the subject;
form a three-dimensional clothing mesh and a three-dimensional body mesh based on the images of the subject;
align the three-dimensional clothing mesh to the three-dimensional body mesh to form a skin clothing boundary and a garment texture;
determine a loss factor based on a predicted cloth position and texture and an interpolated position and texture from the images of the subject; and
update a three-dimensional model including the three-dimensional clothing mesh and the three-dimensional body mesh according to the loss factor, wherein collecting multiple images of a subject comprises capturing the images from the subject with a synchronized multi-camera system.

12. The system of claim 11, wherein to form a three-dimensional body mesh the one or more processors execute instructions to:
determine a skeletal pose from the images of the subject; and
add a skinning mesh with a surface deformation to the skeletal pose.

13. The system of claim 11, wherein to form a three-dimensional body mesh the one or more processors execute instructions to identify exposed skin portions of the subject from the images of the subject as part of the three-dimensional body mesh.

14. The system of claim 11, wherein to form a three-dimensional clothing mesh the one or more processors execute instructions to identify a vertex in the three-dimensional clothing mesh by verifying that a projection of the vertex belongs to a clothing segment on each camera view.

15. The system of claim 11, wherein to align the three-dimensional clothing mesh to the three-dimensional body mesh the one or more processors execute instructions to select and align a clothing segment from the three-dimensional clothing mesh and a body segment from the three-dimensional body mesh.

16. A computer-implemented method, comprising:
collecting an image from a subject;
selecting multiple two-dimensional key points from the image;
identifying a three-dimensional key point associated with each two-dimensional key point from the image;
determining, with a three-dimensional model, a three-dimensional clothing mesh and a three-dimensional body mesh anchored in one or more three-dimensional skeletal poses;
generating a three-dimensional representation of the subject including the three-dimensional clothing mesh, the three-dimensional body mesh and a texture; and
embedding the three-dimensional representation of the subject in a virtual reality environment, in real-time.

17. The computer-implemented method of claim 16, wherein identifying a three-dimensional key point for each two-dimensional key point comprises projecting the image in three dimensions along a point of view interpolation of the image.

18. The computer-implemented method of claim 16, wherein determining a three-dimensional clothing mesh and a three-dimensional body mesh comprises determining a loss factor for the three-dimensional skeletal poses based on the two-dimensional key points.

19. The computer-implemented method of claim 16, wherein embedding the three-dimensional representation of the subject in a virtual reality environment comprises selecting a garment texture in the three-dimensional body mesh according to the virtual reality environment.

20. The computer-implemented method of claim 16, wherein embedding the three-dimensional representation of the subject in a virtual reality environment comprises animating the three-dimensional representation of the subject to interact with the virtual reality environment.
